(19) United States
(12) Patent Application Publication
(10) Pub. No.: US 2016/0102467 A1
(43) Pub. Date: Apr. 14, 2016

(54) LINOLEUM BASED SURFACE COVERINGS AND METHODS FOR INSTALLING SAME

(71) Applicant: ARMSTRONG WORLD INDUSTRIES, INC., Lancaster, PA (US)

(72) Inventors: Matthew S. Myers, Lititz, PA (US); Ronald E. Cramer, Holtwood, PA (US)

(21) Appl. No.: 14/714,316

(22) Filed: May 17, 2015

Related U.S. Application Data
(60) Provisional application No. 62/062,494, filed on Oct. 10, 2014.

(51) Int. Cl. E04F 15/16; D06N 1/00; E04C 2/24; B32B 7/02; E04C 2/16

(52) U.S. Cl. CPC E04F 15/16; B32B 7/02; E04C 2/16; E04C 2/246; D06N 1/00; B32B 2307/584; B32B 2307/734; B32B 2419/04

(57) ABSTRACT

Described herein are methods for unidirectional installation of a surface covering comprising: providing a plurality of floor tiles, each tile comprising: a linoleum core; a top major surface; a bottom major surface; a machine direction edge extending between the top major surface and the bottom major surface running parallel to the machine direction of the tile and; an across machine direction edge extending between the top major surface and the bottom major surface running parallel to the across machine direction of the tile; wherein the machine direction of the tile has a first dimensional stability; and the across machine direction of the tile has a second dimensional stability; placing a first tile on a support base; placing a second tile on the support base adjacent the first tile; and abutting the machine direction edge of the second tile with the machine direction edge of the first tile.

### CROSS-REFERENCE TO RELATED APPLICATIONS

This application is a PCT International Application that claims the benefit of U.S. Provisional Patent Application No. 62/062,494 filed on Oct. 10, 2014. The disclosure of the above application is incorporated herein by reference.

### FIELD OF THE DISCLOSURE

The present disclosure relates to surface covering systems, and more particularly to methods for installing same.

### BACKGROUND

The ability of a floor covering product to remain substantially flat under varying environment conditions is desirable. Dimensional stability (DS) is one applicable measure of floor covering products which may include linoleum panels or tiles. In short, dimensional stability quantifies the characteristic of a floor tile subjected to environmental changes in factors such as ambient relative humidity to remain relatively true to its original shape and dimensions. Excessive growth or shrinkage in dimension may adversely cause curling or doming in individual tiles under low or high relative humidity respectively. Curling causes the edges of the tile to curl upwards with respect to the central portion of the tile. Conversely, doming causes portions of the tile to bow or bubble upwards with respect to the edges. Industry standards such as ASTM F2195-13 or others have been developed to measure the dimensional stability property of floor tiles and set applicable performance levels.

In the production of linoleum floor tiles, continuous formation processes are sometimes used. A relatively wide continuous roll or sheet of linoleum is produced which moves longitudinally along a transport system, typically comprising calenders, rollers and/or conveyors, that defines a machine direction (“MD”). Smaller individual tiles are then cut from the larger material sheet by making cuts both along the machine direction and across machine direction (“AMD”). The MD and AMD are generally defined as being perpendicular to each other. The dimensional stability (DS) varies in both the MD and AMD of the floor product so that each is typically tested and measured separately, with AMD DS typically having a higher value showing poorer performance in that direction of the tile. Ideally, both MD DS and AMD DS should be below the applicable maximums set by industry standard and relatively close in value as possible which is indicative of DS uniformity of the flooring product and resistance to curling and doming

Different edge details have sometimes been used for edges cut in the machine direction versus those cut across machine direction to mask dimensional stability differences between the MD and AMD of the floor tiles. To compensate for these differences in dimensional stability, every other tile is rotated 90 degrees (“quarter turning”) during installation (see, e.g. FIG. 1) so that no MD edge (i.e. edges parallel to the machine direction) directly contacts an AMD edge (i.e. edges parallel to the across machine direction) of adjoining tiles.

The foregoing quarter turn installation method does not allow for unidirectional installation where like MD and AMD edges can be disposed and directly abutted against each other. Accordingly, the only practical tile shape that can be generally produced is a square where every MD edge contacts an AMD edge after quarter turning so no like edge details meet in the installed floor. Unfortunately, this severely limits the visual aesthetics or patterns which may be created with linoleum tiles.

Improvement in dimensional stability of flooring products is desirable. Embodiments of the present invention are designed to meet these needs.

### SUMMARY

Some embodiments of the present invention provide a floor tile with improved dimensional stability that overcomes the foregoing design limitations. In certain embodiments, the floor tile may comprise linoleum. In some embodiments, the floor tiles may comprise isotropic peripheral surface edges (i.e. cross sectional edge profile is identical on all sides). This eliminates a need to use differential MD and AMD edge details for masking dimensional stability differences in the MD versus AMD directions.

Advantageously, some embodiments of the present invention allow unidirectional installation of tiles in the flooring system so that MD edges may be directly abutted against MD edges, and AMD edges may be directly abutted against AMD edges without detriment. Quarter turning tiles for installation is therefore not required. In addition, embodiments of the present invention permit the manufacture and installation of non-square tiles (e.g. rectangular and plank shapes) to form a variety of patterns because like MD-MD edges and/or like AMD-AMD edges may be in direct contact without adversely affecting dimensional stability. Heretofore, tile layouts wherein MD and AMD edges of adjacent tiles were directly abutted to each other were generally unobtainable. Tiles according to the present disclosure therefore allow a wide variety of floor patterns to be formed using non-square tiles, such as without limitation a herringbone, a subway or running bond tile layout (i.e. longitudinally offset joints between adjoining rows of tiles), etc. Accordingly, tile installation techniques and patterns are not strictly limited to the square grid patterns of the past.

In some embodiments, the present invention provides a surface covering comprising a linoleum core; a top major surface and a bottom major surface, a machine direction edge having a first dimensional stability, and an across machine direction edge having a second dimensional stability, wherein the difference between the first and second dimensional stabilities is less than 0.028%. In certain embodiments, the difference is less than 0.02%. In other embodiments, the difference is less than 0.015%.

Some embodiments provide a floor covering system comprising a plurality of floor tiles arranged in edge-to-edge relationship on a support base, each tile comprising a linoleum core, a top major surface, a bottom major surface, a machine direction edge extending parallel to the machine direction; and an across machine direction edge extending parallel to the across machine direction; wherein a pair of floor tiles are arranged such that the machine direction edge of a first tile is abutted against the machine direction edge of the second tile.

Other embodiments provide a floor covering system comprising a plurality of floor tiles arranged in edge-to-edge relationship on a support base, each tile comprising a linoleum core, a top major surface, a bottom major surface, a machine direction edge extending parallel to the machine direction; and an across machine direction edge extending parallel to the across machine direction; wherein a pair of floor tiles are arranged such that the across machine direction edge of a first tile is abutted against the across machine direction edge of the second tile.

Some embodiments provide a method for installing a surface covering system having a unidirectional layout. In some embodiments, the method comprises the steps of: (a) providing a plurality of floor tiles each having a top major surface and a bottom major surface, comprising: a linoleum core; a machine direction edge extending parallel to the machine direction having a first dimensional stability; and an across machine direction edge extending parallel to the across machine direction having a second dimensional stability; (b) placing a first tile on a support base; (c) placing a second tile on the support base adjacent the first tile; and (d) abutting the machine direction edge of the second tile with the machine direction edge of the first tile.

In some embodiments, the method further comprises the step of: placing a third tile on the support base adjacent the first or second tile; and abutting the across machine direction edge of the third tile with the across machine direction edge of the first or second tile. In further embodiments, the method may further include: placing a fourth tile on the support base adjacent the first, second or third tile; abutting the machine direction edge of the fourth tile with the machine direction edge of one of the previously placed tiles; and abutting the across machine direction edge of the fourth tile with the across machine direction edge of one of the previously placed tiles.

### BRIEF DESCRIPTION OF THE DRAWINGS

The features of the exemplary embodiments of the present invention will be described with reference to the following drawings, where like elements are labeled similarly, and in which:

FIG. 1 is a top plan view of a prior art quarter turned flooring system;

FIG. 2 is a side elevation cross-sectional view of a first embodiment of a floor tile for use in a flooring system according to the present disclosure;

FIG. 3 is a side elevation cross-sectional view of a second embodiment of a floor tile for use in a flooring system according to the present disclosure;

FIG. 4 is a top plan view of an exemplary floor tile of the present invention having a square configuration and showing the fabrication process material flow or machine direction;

FIG. 5 is a top plan view of an exemplary floor tile of the present invention having a non-square configuration and showing the fabrication process material flow or machine direction;

FIG. 6 is a top plan view of an exemplary carrier of the present invention; and

FIG. 7 is an exemplary flooring system with a pattern formed by using exemplary square tiles of the present invention.

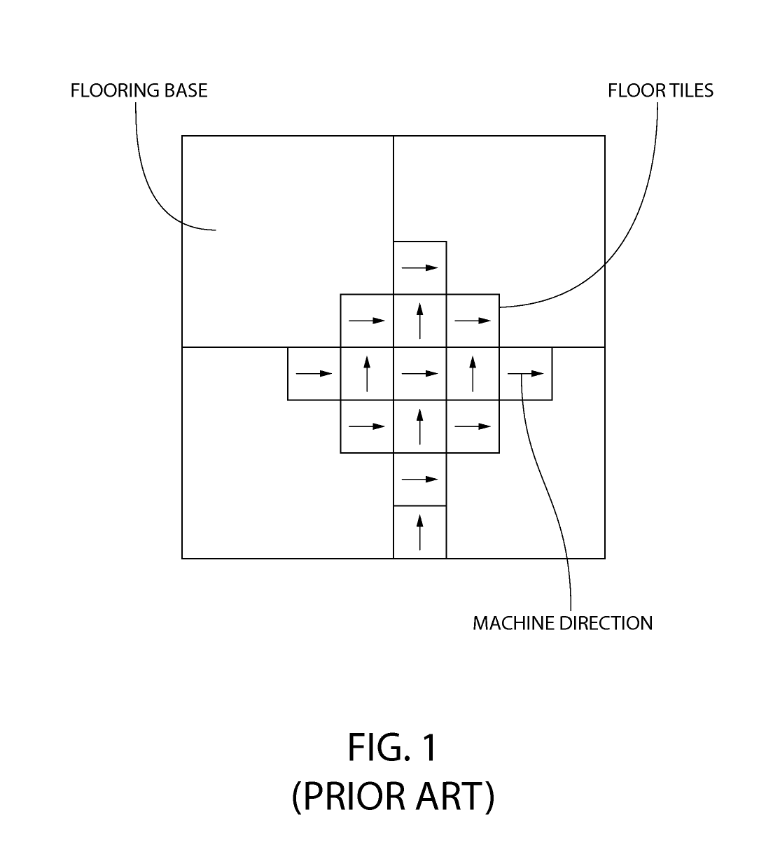

All drawings are schematic and not necessarily to scale. Parts given a reference numerical designation in one figure may be considered to be the same parts where they appear in other figures without a numerical designation for brevity unless specifically labeled with a different part number and described herein.

### DETAILED DESCRIPTION

The features and benefits of the invention are illustrated and described herein by reference to non-limiting exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

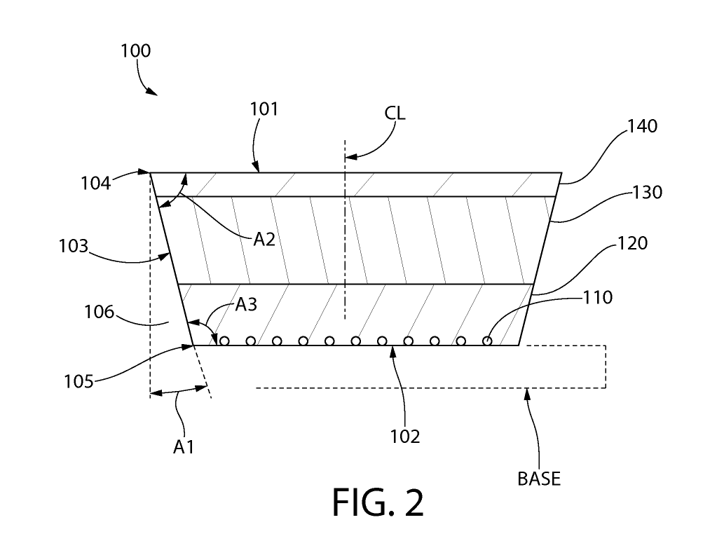

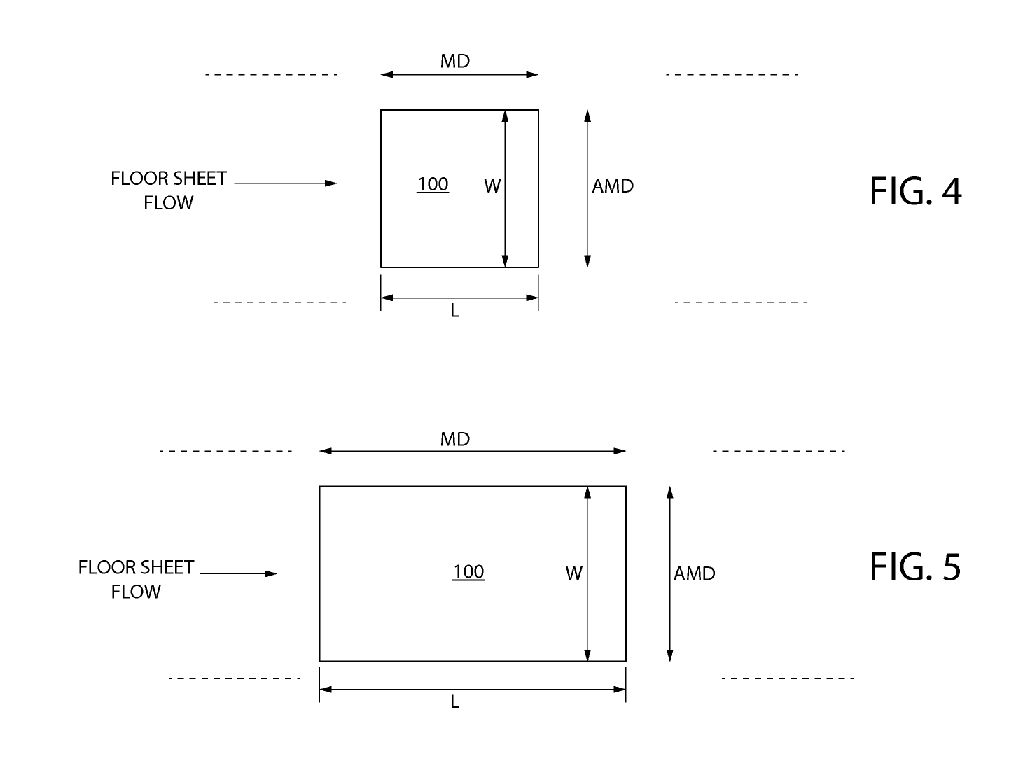

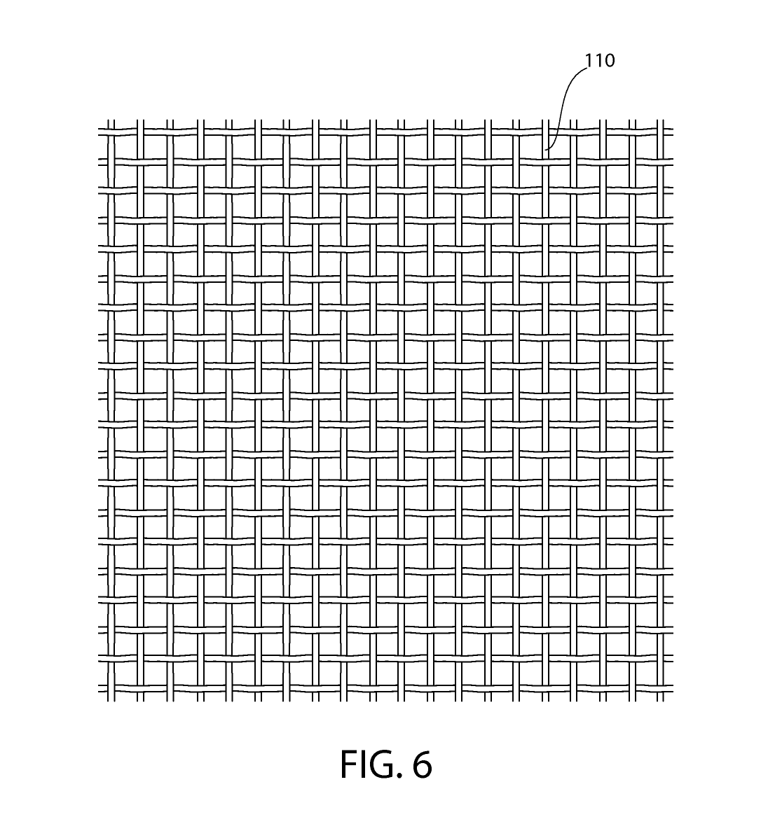

In some embodiments, for example those depicted in FIGS. 2-5, a surface covering (e.g. a floor tile 100) may be used for forming a flooring system comprised of a plurality of floor tiles laid with abutting joints between tiles. In some embodiments, floor tile 100 may be a linoleum tile. The terms “flooring tile” and “product” is used herein for convenience of description only, such flooring products may be applied to any suitable type and oriented surface including without limitation horizontal, vertical, and/or angled or sloped surfaces. Application surfaces or substrates to which the flooring product is mounted may include floors, walls, countertops, ceilings, and others. Accordingly, the invention and non-limiting embodiments of the flooring products described herein are not limited in their application or use strictly to flooring systems alone.

In some embodiments, the surface coverings of the present invention comprise a linoleum core. In some embodiments, the linoleum core comprises a plurality of layers. In some embodiments, the linoleum core comprises a first linoleum layer and a second linoleum layer. In some embodiments, the first linoleum layer comprises a first linoleum composition. In some embodiments, the second linoleum layer comprises a second linoleum composition. In some embodiments, the first linoleum layer comprises a first linoleum composition and the second linoleum layer comprises a second linoleum composition.

Referring now to FIGS. 2-5, a linoleum floor tile 100 generally includes (from the bottom upwards) a carrier 110, a linoleum core 150 comprising a first (or bottom) linoleum layer 120, a second (or top) linoleum layer 130, and a coating 140 disposed on the linoleum core 150. In some embodiments, the second linoleum layer may be a visual linoleum layer in which various decorative additives may be incorporated to create the visual.

In some embodiments, a single homogenous linoleum core may be provided in lieu of a composite structure having distinct first and second linoleum layers.

In some embodiments, floor tile 100 further comprises a top major surface 101, opposing bottom major surface 102, and peripheral edge surfaces 103 extending between the top and bottom major surfaces around the perimeter of the tile. The top and bottom extremities of peripheral edge surfaces 103 define top and bottom edges 104 and 105, respectively which similarly extend around the entire perimeter of the tile 100. Top and bottom edges 104, 105 and peripheral edge surfaces 103 collectively define two pairs of opposing parallel MD and AMD edges for each tile 100 that extend between the top and bottom major surfaces 101, 102. In some embodiments, floor tile 100 further comprises a length L and width W measured in the horizontal plane along the top and bottom major surfaces 101, 102. In various embodiments, length L and width W may be substantially equal or different.

In some embodiments, the carrier is embedded, at least partially, in the first linoleum layer. In those embodiments wherein the carrier is embedded in the first linoleum layer, the first linoleum layer forms the bottom major surface which may be placed adjacent a suitable support base or underlayment. In the case of a flooring system, the support base may be a subfloor.

Any suitable thickness of linoleum floor tile 100 may be used. Some embodiments provide that the overall thickness of the floor tile 100 may be varied, e.g. 2 mm being used for lighter wear applications and greater thicknesses such as 2.5 mm and 3.2 mm being used for more critical applications. However, in general, some embodiments provide that the tile 100 can have an overall thickness of from 1 mm to 6 mm; alternatively from 1.5 mm to 4 mm.

In some embodiments, the first linoleum composition comprises linoleum cement, a first organic filler, and a first inorganic filler. In some embodiments, the second linoleum composition comprises linoleum cement, a second organic filler, and a second inorganic filler. According to some embodiments, the second linoleum layer 130 may have relatively lower concentrations of linoleum cement and relatively higher concentrations of organic filler than the first linoleum layer 120. In some embodiments, the enhanced dimensional stability is the result of reduced sensitivity to changes in moisture. In other words, as relative humidity of the surrounding environment increases or decreases, the linoleum layer is less likely to “dome” at high humidity and “curl” at low humidity.

In some embodiments, the first linoleum composition comprises from about 30 wt. % to about 45 wt. % of linoleum cement, based on the total weight of the first linoleum composition. In some embodiments, the first linoleum composition comprises about 41 wt. % of linoleum cement, based on the total weight of the first linoleum composition.

In some embodiments, the first linoleum composition comprises from about 20 wt. % to about 30 wt. % of a first inorganic filler, based on the total weight of the first linoleum composition. Some embodiments provide that the first inorganic filler comprises particles having an average particle size of from about 0.5 μm to about 20μm. Some embodiments provide that the first inorganic filler comprises particles having an average particle size of from about 1 μm to about 10 μm. Some embodiments provide that the first inorganic filler comprises particles having an average particle size of from about 1 μm to about 5 μm.

Some embodiments provide that the first and/or second inorganic filler may comprise limestone powder (calcium carbonate powder), chalk power, kaolin clay, silica, vermiculite, ball clay or bentonite, talc, mica, gypsum, perlite, titanium dioxide, sand, barium sulfate, dolomite, wollastonite, calcite, pigments, zinc oxide, zinc sulfate, or a combination of two or more thereof.

In some embodiments, the first linoleum composition comprises from about 15 wt. % to about 30 wt. % of a first organic filler, based on the total weight of the first linoleum composition. In some embodiments, the first linoleum composition comprises from about 18 wt. % to about 23 wt. % of the first organic filler, based on the total weight of the first linoleum composition.

Some embodiments provide that the first and/or second organic filler comprises a cellulosic, a polymeric material, a non-polymeric material, or a combination of two or more thereof. In some embodiments, the first and/or second organic filler may be a fibrous material or a particulate material. In some embodiments, the first and/or second organic filler comprises a cellulosic material selected from wood fibers, cork, wood shavings, wood flour, paper fibers, cotton linters, a combination of two or more thereof.

In some embodiments the wood flour may be made from a hardwood or a softwood. In some embodiments, the wood flour comprises particles having a particle size distribution as follows: <160 μm: 40-90%, and <80 μm 10-50%. In other embodiments, the wood flour comprises particles having a particle size distribution as follows: <160 μm 50-85%; and <80 μm 10-30%.

The polymeric material may include polyolefin, and the non-polymeric material may include a hydrophobic material. In some embodiments, the hydrophobic material has a melting point below 100° C. In some embodiments, the non-polymeric material is selected from Montan wax; Carnauba wax; bee wax; paraffin; and a combination of two or more thereof.

In some embodiments, the non-polymeric material may be present in an amount ranging from about 0.1 wt. % to about 1 wt. % based on the total weight of the first linoleum composition. In some embodiments, the non-polymeric material may be present in an amount ranging from about 0.1 wt. % to about 0.6 wt. % based on the total weight of the first linoleum composition.

In some embodiments, the thickness of the first linoleum layer 120 may be varied and range from about 0.5 mm to about 5 mm; alternatively from about 0.75 mm to about 3 mm; alternatively from about 0.9 mm to about 1.1 mm.

In some embodiments, the second linoleum composition comprises from about 17.5 wt. % to about 70 wt. % of linoleum cement, based on the total weight of the second linoleum composition. In some embodiments, the second linoleum composition comprises from about 25 wt. % to about 45 wt. % of linoleum cement, based on the total weight of the second linoleum composition. In some embodiments, the second linoleum composition comprises from about 30 wt. % to about 40 wt. % of linoleum cement, based on the total weight of the second linoleum composition. In some embodiments, the second linoleum composition comprises about 36 wt. % of linoleum cement, based on the total weight of the second linoleum composition.

In some embodiments, the second linoleum composition comprises from about 10 wt. % to about 20 wt. % of the second inorganic filler, based on the total weight of the second linoleum composition. In some embodiments, the second linoleum composition comprises from about 12 wt. % to about 18 wt. % of the second inorganic filler, based on the total weight of the second linoleum composition. In some embodiments, the second linoleum composition comprises about 14 wt. % of the second inorganic filler, based on the total weight of the second linoleum composition.

Some embodiments provide that the second linoleum composition comprises a second organic filler. In some embodiments, the second linoleum composition comprises from about 30 wt. % to about 45 wt. % of a second organic filler, based on the total weight of the second linoleum composition. In some embodiments, the second linoleum composition comprises from about 36 wt. % to about 41 wt. % of the second organic filler, based on the total weight of the second linoleum composition. In some embodiments, the second linoleum composition comprises about 39 wt. % of the second organic filler, based on the total weight of the second linoleum composition.

In some embodiments, the thickness of the second (or top) linoleum layer 130 may be varied and range from about 0.5 mm to about 5 mm; alternatively from about 0.75 mm to about 3 mm; alternatively from about 1.1 mm to about 1.4 mm In certain embodiments, the thickness of second linoleum layer 130 may be greater than the thickness of the first or linoleum layer 120.

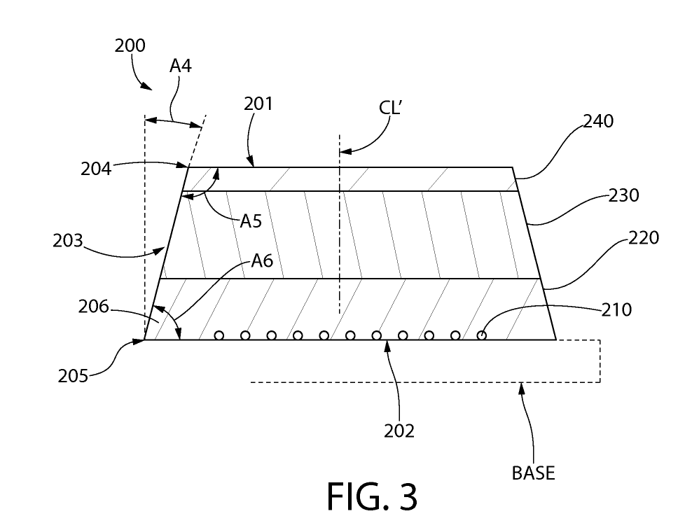

In some embodiments, such as described in FIGS. 2 and 3, the surface covering may further comprise coating 140. In some embodiments, coating 140 may perform as a wear layer. In some embodiments, coating 140 is applied to the second linoleum composition. In some embodiments, coating 140 is UV curable, moisture curable or thermally curable. In some embodiments, coating 140 may be transparent and cured by UV radiation. In some embodiments, coating 140 provides good scratch and abrasion resistance and is sufficiently transparent to allow a print design to be visible from and through the topside of the product. In some embodiments, coating 140 comprises a UV curable polyurethane. In some embodiments, coating 140 comprises a moisture curable polyurethane. In some embodiments, coating 140 comprises an acrylate. In some embodiments, coating 140 comprises a polyurethane and an acrylate.

In some embodiments, coating 140 may comprise particles that enhance dimensional stability and/or scratch resistance. In some embodiments, the particles are selected from chalk, barium sulfate, slate powder, silica, kaolin, quartz powder, talc, lignin, powdered glass, aluminum oxide, and glass fibers.

In some embodiments, coating 140 may have a thickness that ranges from about 0.001 to 0.1 mm. In some embodiments coating 140 may have a thickness that ranges from about 0.01 to 0.07 mm. In some embodiments coating 140 may have a thickness that ranges from about 0.015 to 0.05 mm.

In some embodiments, carrier 110 enhances the mechanical integrity of the floor tile 100 by acting as a backbone to the overall surface covering. In some embodiments, carrier 110 may be partially or completely embedded in the bottom linoleum layer 120 near the bottom surface 102 of the first linoleum layer. Embedding the carrier 110 in the bottom linoleum layer 120 may contribute to improving the dimensional stability of the floor tile 100 in some embodiments.

In some embodiments, carrier 110 may include a binder and a fibrous material. In some embodiments, the fibrous material is woven or knitted. In some embodiments, the binder may be present in an amount ranging from about 0 wt. % to about 40 wt. %, based on the weight of carrier 110. In other embodiments, the binder may be present in an amount ranging from about 1 wt. % to about 30 wt. % based on the weight of carrier 110.

According to some embodiments, the fibrous material may be selected from a synthetic fiber, a cellulosic fiber, a natural fiber, a synthetic fabric, and a combination of two or more thereof.

In some embodiments, the synthetic fiber may be selected from a polyester (e.g. polyethylene terepthalate), a polyolefin (e.g. polypropylene), polytetrafluoroethylene, polyacrlyonitrile, a polyamide (e.g. nylon), polyacrylate, fiberglass, etc., and a combination of two or more thereof. In some embodiments, the cellulosic fiber and natural fiber may be selected from cotton, jute, viscose, kraft paper, rayon, sisal, and a combination of two or more thereof. Some embodiments provide that the carrier may comprise a material selected from: jute fabric; a mixed fabric of natural fibers; carbon fibers; aramid fibers; quartz fibers; alumina fibers; silicon carbide fibers; and a combination of two or more thereof.

In some embodiments, the carrier comprises polyethylene terephthalate. In some embodiments, the carrier comprises polyethylene terephthalate and fiberglass.

In some embodiments, the binder may comprise a thermoplastic resin or a thermoset resin that is selected from, epoxies, polyurethanes, acrylic latex, phenolic resin, polyvinyl alcohol, carbohydrate polymers (i.e. starch), a cellulosic resin, a polyacrylamide, urea-formaldehyde, a melamine resin (e.g. melamine-formaldehyde, melamine-phenol-formaldehyde copolymer), an acrylic copolymer, styrene butadiene rubber, and a combination of two or more thereof. In some embodiments the binders may include one or more resins derived from the following monomers vinyl acetate, vinyl propionate, vinyl butyrate, vinyl chloride, vinylidine chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methylacrylate, styrene, butadiene, urethane, epoxy, melamine, and an ester.

In some embodiments, the peripheral edge surfaces 103 may be undercut and disposed at an inward angle A1 measured from the top edge 104 between 0 and 90 degrees to a vertical reference plane intersecting top edge 104 and extending perpendicular to the top and bottom major surfaces 101, 102, as shown in FIG. 2. The vertical reference plane is parallel to centerline CL of the floor tile 100. Peripheral edge surfaces 103 may be planar and form an acute angle A2 with respect to the top major surface 101 and an obtuse angle A3 with respect to the bottom major surface 102. Each peripheral edge surface 103 is therefore oblique to the top and bottom major surfaces of floor tile 100.

In some embodiments, angle A2 may be from about 2 degrees to about 75 degrees, alternatively from about 5 degrees to about 45 degrees, and alternatively in certain embodiments from about 10 degrees to about 20 degrees. The undercut profile forms a top major surface 101 which is greater in width W and length L (measured between the top peripheral edges 104 along the horizontal plane defined by the top major surface) than the width W and length L of the bottom major surface 102 (measured between bottom peripheral edges 105 along the horizontal plane defined by the bottom major surface). Accordingly, the peripheral edge surfaces 103 slope inwards towards the centerline CL of the tile going from the top major surface 101 of the tile 100 to the bottom major surface 102 such that the bottom edge 105 is inwardly offset from the top edge 104 with respect to centerline CL of the tile.

With continuing reference to FIG. 2, the perimeter gap 106 may have a substantially triangular shape in cross section with base of the triangle being formed by the support base or underlayment (e.g. subfloor) on which the floor tile 100 is placed. The gap 106 is therefore widest adjacent the bottom edge 105 of the tile 100 at the base-to-tile interface than at the top edge 104 which forms an upper apex of the gap. When two tiles 100 are placed in edge-to-edge abutting contact, the triangular cross section formed by the mating gaps 106 of each tile form an isosceles triangle in cases where each tile has a substantially similar peripheral edge surface 103 profile (allowing for tolerances in cutting or filing the tile edges to shape).

In some embodiments, all peripheral edge surfaces 103 may be angled so that the tile 100 has an undercut edge profile on all four MD and AMD edges. In some embodiments, the angles A1 may be identical on all four sides providing four isotropic tile edges in cross sectional profile. In other embodiments, the angles A1 may be different. In certain embodiments, the angles A1 may be identical on the opposing MD sides of the tile and the angles A1 may be identical on the AMD sides of the tile but different than the MD side angle.

According to another aspect of the invention, unidirectional tile layout may be produced using non-square tiles. In some embodiments, using rectangular or plank-shaped tiles, machine direction (MD) peripheral edge surfaces are directly abutted against across machine direction (AMD) peripheral edge surfaces. Significantly, MD edges of two adjoining tiles may be directly abutted. Advantageously, this allows creation of a wide variety of floor patterns not heretofore achievable with linoleum tiles that could only be laid with AMD-MD edge contact for masking dimensional stability differences. In addition, a combination of non-square tiles (e.g. rectangular) may be mixed with square tiles in a single flooring system without regard for which peripheral edge surfaces (MD or AMD) abut each other in the layout. This is possible due to the improvement in dimensional stability attributable to isotropic peripheral surface edge profiles, angled peripheral surface edge profiles, and/or tile size.

In some embodiments, the isotropic peripheral edge profile comprises an overcut edge profile. In some embodiments, the isotropic peripheral edge profile comprises an undercut edge profile. In other embodiments, the isotropic peripheral edge profile comprises a peripheral surface that is perpendicular to the top major surface and bottom major surface and extends between a top edge and bottom edge of the surface covering.

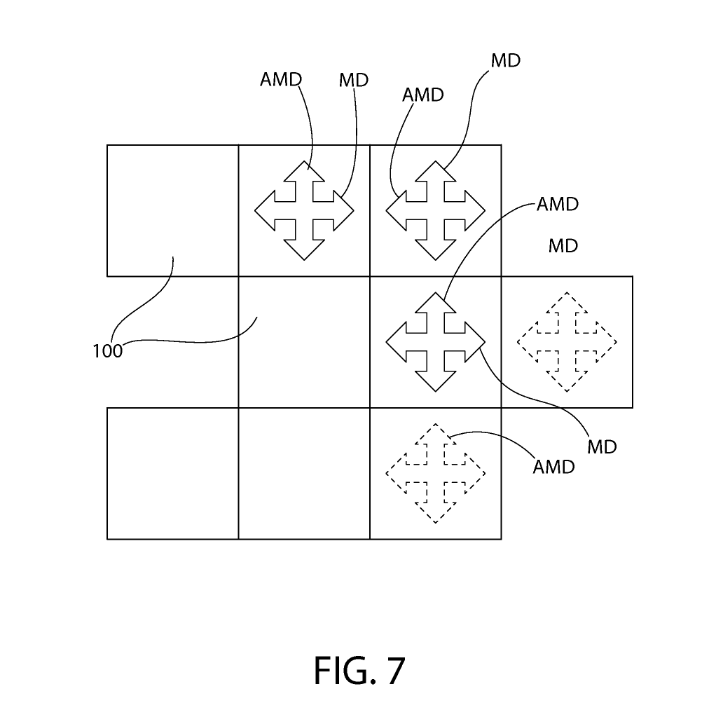

As shown in FIG. 7, a unidirectional tile layout may also be produced using square tiles 100 in which MD edges can directly contact MD edges of adjoining tiles, or AMD edges can directly contact AMD edges of adjoining tiles without concern. This is attributable, at least in part, to the tiles 100 according to the present disclosure having isotropic edge profiles. The directional arrows show the MD and AMD direction and illustrate the tile orientation and layout possible. In the layout shown, a combination of AMD-MD edge contact and AMD-AMD/MD-MD edge contact is possible (emphasized by dashed arrows in which an AMD edge of one tile abuts an AMD edge of another and MD edge of one tile abuts MD edge of another). The direction of the tiles 100 laid may therefore be random.

An exemplary method for installing floor tiles according to the present invention may include providing a plurality of floor tiles 100.

Advantageously, the floor tiles 100 and corresponding flooring systems described herein remove the restrictions for installing floors and shapes of tile which can be utilized due to improved dimensional stability.

In some embodiments, the peripheral edge surfaces 103 of tile 100 are sealed to minimize moisture absorption by the tile, which might cause distortion and contribute to curling or doming. In some embodiments, a polymeric seal coat or sealant such as without limitation polyurethane may be applied to the cut tile MD and AMD peripheral edge surfaces 103 to serve as moisture barrier. Other suitable polymeric coatings may be used for this purpose.

In further embodiments, such as the embodiment depicted in FIG. 3, the peripheral edge surfaces 203 may be overcut and sloped outwards going from the top major surface 201 to the bottom major surface 202. Edge surfaces 203 are disposed at an angle A4 measured from the tile bottom edge 205 between 0 and 90 degrees to a vertical reference plane intersecting bottom edge 205 and extending perpendicular to the top and bottom major surfaces 201, 202, as shown in FIG. 3. The vertical reference plane is parallel to centerline CL′ of floor tile 200. Peripheral edge surfaces 203 may be planar and form an obtuse angle AS with respect to the top major surface 201 and an acute angle A6 with respect to the bottom major surface 202. Each peripheral edge surface 203 is therefore oblique to the top and bottom major surfaces of floor tile 200.

In some exemplary embodiments, without limitation, angle A4 may be from about 5 degrees to about 30 degrees, and alternatively in certain embodiments from about 10 degrees to about 20 degrees. In other embodiments, (see, e.g. FIG. 3) the overcut profile forms a top major surface 201 which is smaller in width W and length L (measured between the top peripheral edges 204 along the horizontal plane defined by the top major surface) than the width W and length L of the bottom major surface 202 (measured between bottom peripheral edges 205 along the horizontal plane defined by the bottom major surface). Accordingly, the peripheral edge surfaces 203 slope outward towards the centerline CL′ of the tile going from the top major surface 201 of the tile 200 to the bottom major surface 202 such that the top edge 204 is inwardly offset from the bottom edge 205 with respect to centerline CL′ of the tile 200.

Without intending to be bound by theory, the present inventors believe that overcutting the peripheral edge surfaces 203 of tile 200 improves the dimensional stability of tile 200 by creating free volume defined by a gap or space 206 proximate to the top peripheral edges 204 around the top perimeter of the tile 200 which allows for expansion under high relative humidity conditions. Advantageously, this allows MD and AMD edges to be directly abutted during installation, permitting the use of non-square tiles that can create a wide variety of patterns.

With continuing reference to FIG. 3, the perimeter gap 206 may have a substantially triangular shape in cross section with the base of the triangle being formed adjacent the top edge 204 of tile 200 and the pointed tip by the support base or underlayment (e.g. subfloor) on which the floor tile is placed. The gap 206 is therefore widest adjacent the top edge 204 of tile 200. The bottom apex of the gap therefore is disposed at the base-to-tile interface at the tile bottom edge 205. When two tiles 200 are placed in edge-to-edge abutting contact, the triangular cross section formed by the mating gaps 206 of each tile forms an isosceles triangle in cases where each tile has a substantially similar peripheral edge surface 203 profile (allowing for tolerances in cutting or filing the tile edges to shape).

In some embodiments, all peripheral edge surfaces 203 may be angled so that the tile 200 has an overcut edge profile on all four peripheral edge surfaces. In some embodiments, the angles A4 may be identical on all four sides providing four isotropic tile edges in cross sectional profile. In other embodiments, the angles A4 may be different. In certain embodiments, the angles A4 may be identical on the opposing MD sides of the tile and the angles A4 may be identical on the AMD sides of the tile, but different than the MD side angle. Numerous variations are possible.

### EXAMPLES

### Example 1

Table 1 (below) describes a comparison of dimensional stability (DS) performance between an exemplary surface covering of the present invention and a comparative surface covering. The surface coverings are conditioned; and dimensional stability for Across Machine Direction (AMD) and Machine Direction (MD) are measured according to the EN 669 standard.

TABLE 1

| | MD DS | AMD DS | AMD DS and MD DS Difference |
|---|---|---|---|
| Product | (%) | (%) | (%) |
| Ex. I | 0.044 | 0.056 | 0.012 |
| Comp. Ex. I | 0.038 | 0.066 | 0.028 |

The data described in Table 1 (above) demonstrates that exemplary surface coverings of the present invention provide significantly greater dimensional stability than comparative surface coverings, as evidenced by better AMD DS and a lesser difference between AMD DS and MD DS.

### Example 2

The dimensional stability of exemplary surface coverings of the present invention is evaluated against the dimensional stability of comparative surface coverings at a temperature of 25° C. and 80% relative humidity (RH). Table 2 (below) describes the results of these evaluations. Specifically, the dimensional stability values provided for Example II (Ex. II) represent the average dimensional stability demonstrated by four (4) surface coverings having a ten degree (10°) overcut edge profile on the peripheral surfaces; and the dimensional stability values provided for Comparative Example II (Comp. Ex. II) represent the average dimensional stability demonstrated by four (4) surface coverings having a ten degree (10°) undercut edge profile on the peripheral surfaces. Similarly, the dimensional stability values provided for Example III (Ex. III) represent the average dimensional stability demonstrated by three (3) surface coverings having a ten degree (10°) overcut edge profile on the peripheral surfaces; and the dimensional stability values provided for Comparative Example III (Comp. Ex. III) represent the average dimensional stability demonstrated by three (3) surface coverings having a ten degree (10°) undercut edge profile on the peripheral surfaces. Aside from the peripheral surface edge profiles, the composition and structure of all of the surface coverings evaluated are identical.

TABLE 2

Dimensional Stability (%)

| | | Machine | Across Machine |
|---|---|---|---|
| Example | Scrim | Direction | Direction |
| Ex. II | Glass/PET | 0.06 | 0.07 |
| Comp. Ex. II | Glass/PET | 0.08 | 0.11 |
| Ex. III | PET/PET | 0.09 | 0.10 |
| Comp. Ex. III | PET/PET | 0.09 | 0.15 |

As demonstrated by the data described in Table 2 (above), exemplary surface coverings of the present invention having an “overcut” peripheral surface edge profile provide more uniform MD and AMD dimensional stability than the comparative surface coverings which do not include an “overcut” peripheral surface edge profile. The greater uniformity in MD and AMD dimensional stability is evidenced by the lesser difference in MD and AMD dimensional stability exhibited by the surface coverings of the present invention.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A linoleum tile comprising:
a carrier;
a linoleum core;
a top major surface and a bottom major surface;
a machine direction edge having a first dimensional stability; and
an across machine direction edge having a second dimensional stability;
wherein a difference between the first and second dimensional stabilities is less than 0.028%.

2. The linoleum tile according to claim 1, wherein the difference between the first dimensional stability and second dimensional stability is less than 0.02%.

3. The linoleum tile according to claim 1, wherein the difference between the first dimensional stability and second dimensional stability is less than 0.015%.

4. The linoleum tile according to any one of claim 1, wherein the machine direction dimensional stability is less than 0.04%.

5. The linoleum tile according to any one of claim 1, wherein the across machine direction dimensional stability is less than 0.07%.

6. The linoleum tile according to any one of claim 1, further comprising a machine direction edge extending parallel to the machine direction and an across machine direction edge extending parallel to the across machine direction, the machine direction and across machine direction edges each including a peripheral edge surface extending between the top and bottom major surfaces, each edge surface being planar and oriented obliquely to the top major surface and the bottom second major surface.

7. The linoleum tile of according to claim 1, wherein the machine direction edge and across machine direction edge have an isotropic edge profile in cross sectional view.

8. The linoleum tile according to claim 1, wherein the linoleum core comprises a first linoleum layer and a second linoleum layer.

9. The linoleum tile according to claim 8, wherein the carrier is embedded in the first linoleum layer.

10. The linoleum tile according to claim 1 further comprising a wear layer.

11. The linoleum tile according to claim 9, wherein first linoleum layer forms the bottom major surface.

12. A floor covering system comprising:
a plurality of floor tiles arranged in edge-to-edge relationship on a support base, each tile comprising:
a linoleum core comprising a plurality of linoleum layers;
a top major surface;
a bottom major surface;
a machine direction edge extending parallel to the machine direction;
an across machine direction edge extending parallel to the across machine direction;
the machine direction of the tile having a first dimensional stability and the across machine direction of the tile having a second dimensional stability;
wherein a first tile and a second tile are arranged such that the machine direction edge or across machine direction edge of the first tile is abutted against the respective machine direction edge or across machine direction edge of the second tile.

13. The flooring covering system according to claim 12, wherein a difference between the first and second dimensional stabilities is less than 0.028%.

14. The flooring covering system according to claim 12, wherein each tile comprises two parallel machine direction edges and two parallel across machine direction edges.

15. The flooring covering system according to claim 12, further comprising a second pair of tiles arranged such that the machine direction edges of the second pair of tiles are adjoined.

16. The floor covering system according to claim 12, further comprising a third pair of tiles arranged such that the across machine direction edges of the third pair tiles are adjoined.

17. The surface covering according to claim 12, wherein the first tile and the second tile are square in shape.

18. The surface covering according to claim 12, wherein the first tile and the second tile are rectangular in shape.

19. The surface covering according to claim 12, wherein the machine direction edge and across machine direction edge each includes a top edge, a bottom edge, and a peripheral surface edge extending between the top major surface and the bottom major surface, each peripheral surface edge being planar and disposed at an angle from about 5 degrees to about 30 degrees with respect to a vertical reference plane that intersects the top major surface of the linoleum core.

20. The surface covering according to claim 19, wherein the angle is from about 10 degrees to about 20 degrees.
